(19) United States
(12) Patent Application Publication
(10) Pub. No.: US 2020/0111054 A1
(43) Pub. Date: Apr. 9, 2020

(54) AUTOMATED CLAIMS AUDITING

(71) Applicant: International Business Machines Corporation, Armonk, NY (US)

(72) Inventors: Radu Marinescu, Dublin (IE); Akihiro Kishimoto, Castleknock (IE); Spyros Kotoulas, Dublin (IE); Vanessa Lopez Garcia, Dublin (IE)

(21) Appl. No.: 16/151,041

(22) Filed: Oct. 3, 2018

(51) Int. Cl. G06Q 10/10; G06Q 40/08; G06F 17/27; G06F 17/18

(52) U.S. Cl. CPC G06Q 10/10; G06F 17/18; G06F 17/27; G06Q 40/08

(57) ABSTRACT

Techniques for automated auditing claims are presented. A policy processor component can determine conditions and constraints relating to claim validity, based on a result of an analysis of policy data of a set of policies associated with a service identity and relating to services and procedures, to facilitate generation of probabilistic logic data relating to the conditions and constraints relating to the claim validity. The policy processor component can encode the conditions and the constraints to generate the probabilistic logic data, and store the probabilistic logic data and information relating to the conditions and constraints in a knowledge database component. A claim management component can determine a validity status of a claim and a probability that the validity status is correct based on evaluation of the probabilistic logic data and claim data relating to the claim. The validity status can be valid or invalid.

### BACKGROUND

The subject disclosure relates to claim auditing, and more specifically, to automated claims auditing.

### SUMMARY

The following presents a summary to provide a basic understanding of one or more embodiments of the disclosed subject matter. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, structures, computer-implemented methods, apparatuses, and/or computer program products that can facilitate performing claims auditing, such, for example, automated claims auditing, are provided.

According to an embodiment, a system can comprise a memory that stores computer-executable components; and a processor, operatively coupled to the memory, that executes computer-executable components. The computer-executable components can comprise a policy processor component that determines conditions and constraints relating to claim validity, based on a result of an analysis of policy data of a set of policies associated with a service identity and relating to services and procedures, to facilitate generation of probabilistic logic data relating to the conditions and the constraints relating to the claim validity. The computer-executable components also can include a claim management component that determines a validity status of a claim and a probability that the validity status is correct based on an evaluation of the probabilistic logic data and claim data relating to the claim.

Another embodiment, a computer-implemented method that can comprise determining, by a system operatively coupled to a processor, conditions and constraints relating to claim validity, based on a result of analyzing policy information of a set of policies associated with a service identity and relating to services and procedures, to facilitate generating probabilistic information relating to the conditions and the constraints relating to the claim validity. The computer-implemented method also can include determining, by the system, a validity status of a claim and a probability that the validity status is correct based on an evaluation result of evaluating the probabilistic information and claim information relating to the claim.

A further embodiment relates to a computer program that facilitates evaluating a validity of a claim, the computer program product comprising a computer readable storage medium having program instructions embodied therewith. The program instructions are executable by a processor to cause the processor to determine conditions and constraints relating to claim validity, based on a result of an analysis of policy data of a set of policies associated with a service identity and relating to services and procedures, to facilitate generation of probabilistic logic data relating to the conditions and the constraints relating to the claim validity. The program instructions also are executable by the processor to cause the processor to determine a validity status of a claim and a probability that the validity status is correct based on an evaluation of the probabilistic logic data and claim data relating to the claim.

These and other features will become apparent from the following detailed description of illustrative embodiments thereof, which is to be read in connection with the accompanying drawings.

### DESCRIPTION OF THE DRAWINGS

FIG. 1 illustrates a block diagram an example, non-limiting system that can perform automated auditing of claims, in accordance with various aspects and embodiments of the disclosed subject matter.

FIG. 2 depicts a diagram of example probabilistic logic data associated with a policy document of a set of policies of a service entity, in accordance with various aspects and embodiments of the disclosed subject matter.

FIG. 3 illustrates a diagram of an example auditing of claims, in accordance with various aspects and embodiments of the disclosed subject matter.

FIG. 4 depicts a block diagram of an example flow process for automated auditing of claims, in accordance with various aspects and embodiments of the disclosed subject matter.

FIG. 5 presents a block diagram of an example claim processor component, in accordance with various aspects and embodiments of the disclosed subject matter.

FIG. 6 illustrates a flow diagram of an example, non-limiting method for automated auditing of claims, in accordance with various aspects and embodiments of the disclosed subject matter.

FIG. 7 depicts a flow diagram of an example, non-limiting method for generating probabilistic information relating to conditions and constraints relating to claim validity from a set of policies associated with a service identity, and storing the probabilistic information in a knowledge database, to facilitate automated auditing of claims, in accordance with various aspects and embodiments of the disclosed subject matter.

FIG. 8 illustrates a flow diagram of an example, non-limiting method for determining the validity status of a claim to facilitate automated auditing of claims, in accordance with various aspects and embodiments of the disclosed subject matter.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Claim auditing can be desirable (e.g., useful and/or important) and beneficial for insurance entities (e.g., insurance companies that issue and manage health, automobile, home, life, mortgage, and/or other types of insurance) as well as other types of entities that have a business that handles or deals in claims or other business issues akin or similar to claims. Bad claims can cost an entity a significant amount of money, so it can be desirable to audit claims to ensure they are valid and accurate in order to reduce or minimize invalid claims. Claim auditing also can facilitate improving investigator productivity to identify and find evidence for more invalid claims.

However, auditing claims typically can be largely a manual process, which can be quite costly and time consuming, since workers often can spend a significant amount of time reviewing and auditing claims to determine whether the claims are valid and accurate, or are instead invalid.

Various embodiments disclosed herein relate to techniques for automated auditing claims. A claim processor component can comprise a policy processor component and a claim management component. The policy processor component can determine conditions and constraints relating to claim validity, based at least in part on a result of an analysis of policy data of a set of policies associated with a service identity and relating to services and procedures, to facilitate generation of probabilistic logic data relating to the conditions and the constraints relating to the claim validity. In some embodiments, the policy data can be in a natural language format, and the policy processor component can analyze the policy data in the natural language format to determine the conditions and the constraints relating to claim validity that are associated with the set of policies.

The policy processor component can encode the conditions and the constraints to generate the probabilistic logic data, and can store the probabilistic logic data and information relating to the conditions and the constraints in a knowledge database component. The probabilistic logic data can comprise probabilistic logic formulas relating to the conditions and the constraints relating to claim validity.

The claim management component can receive claim data relating to a claim that is to be audited. The claim management component can determine a validity status of a claim and a probability that the validity status is correct based at least in part on evaluation of the probabilistic logic data and claim data relating to the claim. For instance, the claim management component can access the probabilistic logic data, or portion thereof, from the knowledge database component, and can evaluate the probabilistic logic data and the claim data relating to the claim being audited. The validity status of the claim can be, for example, valid or invalid. In some embodiments, the claim management component can determine a reason (e.g., the most likely reason) for the validity status, as determined. For instance, the claim management component can determine the reason for the validity status, wherein the reason can have the highest probability of being the correct reason for the validity status as compared to other probabilities of other reasons for the validity status that are potentially the correct reason.

These and other aspects and embodiments of the disclosed subject matter will now be described with respect to the drawings.

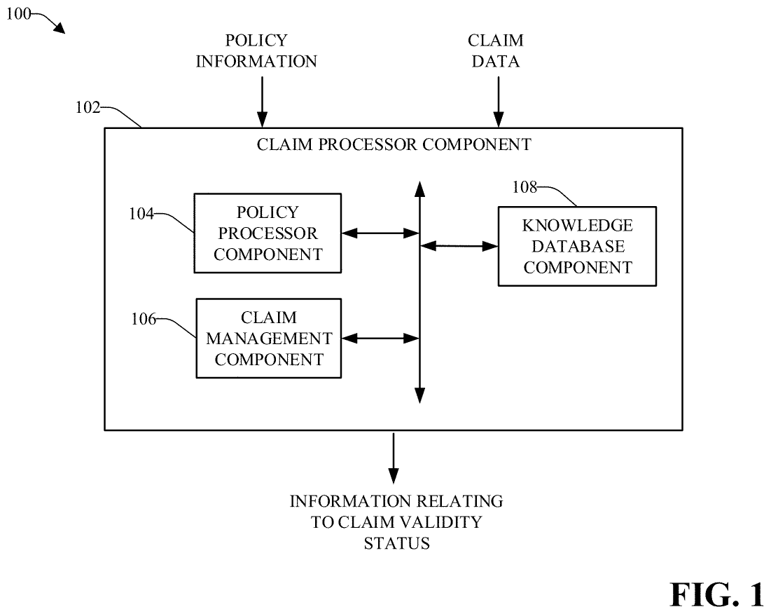

FIG. 1 illustrates a block diagram an example, non-limiting system 100 that can perform automated auditing of claims, in accordance with various aspects and embodiments of the disclosed subject matter. The system 100 can be utilized to desirably perform automated auditing of claims using a set of policies of a service entity (e.g., insurance company or other type of service entity) and claim information regarding claims under audit. The system 100, by using the techniques described herein to perform automated auditing of claims, can reduce or minimize errors, time, and/or costs associated with auditing claims (e.g., using people to manually audit claims). The system 100, by using the techniques described herein to perform automated auditing of claims, also can enhance accuracy in determining whether claims are valid or invalid. The system 100, by using the techniques described herein to perform automated auditing of claims, can reduce or minimize undesirable costs (e.g., undesirable, improper, or erroneous claim payments) associated with invalid claims through enhanced automated determinations regarding whether claims are valid or invalid.

The system 100 can comprise a claim processor component 102 that can perform automated auditing and processing of claims relating to a policy (e.g., insurance policy) or other type of agreement or contract between one entity (e.g., person, business, . . . ) and a service entity (e.g., insurance company, another type of business entity, a government entity (e.g., government agency, such as Medicare or Medicaid), . . . ) that can provide services (e.g., insurance coverage, payment of claims, . . . ) under the policy, agreement, or contract. The policy, agreement, or contract can relate to, for example, health insurance, automobile insurance, home insurance, business insurance, life insurance, mortgage insurance, and/or other types of insurance, as well as other types of business activities that handle or deal in claims or other business issues akin or similar to claims (e.g., claims relating to a policy, agreement, or contract).

The claim processor component 102 can comprise a policy processor component 104 and a claim management component 106. The policy processor component 104 can receive a set of policies (e.g., set of business or claim processing policies) associated with a service entity. The policy processor component 104 can analyze policy information contained in the set of policies. The policy information can specify or indicate conditions or constraints, and/or procedure information (e.g., procedure codes, such as procedure codes for medical conditions or diagnoses) for procedures or services (e.g., medical procedures or services, repair services (e.g., home or automobile repair services), replacement services (e.g., home or automobile replacement services), . . . ) relating to processing, auditing, and/or determining the validity status of claims. The policy information can comprise, for example, rules associated with the services and rules associated with procedure codes relating to the procedures or services that can be covered by the service entity (e.g., under an insurance policy, agreement, or contract). For instance, the policy information can specify or indicate conditions or constraints under which a claim can be determined to be valid (e.g., claim is valid and payment on the costs of the claim is proper), and/or can specify or indicate situations (e.g., breaches or violations of conditions or constraints) where a claim can be determined to be invalid (e.g., where payment of all or at least a portion of the payment demand in the claim can be determined to be improper).

For example, the policy information can specify or indicate one or more entities (e.g., persons, medical service providers, other service providers, . . . ) that are authorized (e.g., permitted) to present claims for payment (e.g., under an insurance policy issued to a customer), wherein other entities that are not specified or indicated as authorized by the policy information can be entities that are not authorized to present claims for payment. As another example, the policy information can specify or indicate one or more prescription medications that can properly be prescribed to a person (e.g., patient covered by health insurance) for a diagnosis of a medical condition of the person, wherein other prescription medications not specified or indicated for such diagnosis by the policy information can be deemed unauthorized or improper. As still another example, the policy information can specify or indicate ranges of or maximum prescription levels for prescription medications that are authorized to be prescribed with respect to such diagnosis of the medical condition (e.g., up to a maximum of a 30-day supply of a prescription medication for a filling of the prescription, up to a maximum of 6 refills of the prescription medication over a one-year period, and/or up to 4 doses of the prescription medication per day), wherein other prescription levels for a particular prescription medication that are outside of the prescription level authorized by the policy information can be deemed unauthorized or improper. As yet another example, the policy information can specify or indicate a maximum number of units authorized for a particular procedure code for a member for a defined period of time (e.g., maximum number of claims for the particular procedure code is 4 units per day), wherein other numbers of units for that particular procedure code that are greater than the maximum number of units authorized by the policy information can be deemed unauthorized or improper.

In some embodiments, the policy information can be in a natural language format. As part of the analyzing of the policy information, the policy processor component 104 can employ natural language format analysis, wherein the policy processor component 104 can parse the policy information in the natural language format to facilitate determining the conditions and constraints relating to claim validity that are associated with the set of policies.

Based at least in part on the results of the analysis of policy information, the policy processor component 104 can determine (e.g., automatically determine) the conditions and the constraints relating to claim validity for the set of policies associated with the service identity, to facilitate generation of probabilistic logic data relating to the conditions and the constraints relating to the claim validity. For instance, based at least in part on the analysis of the set of policies, the policy processor component 104 can extract (e.g., automatically extract) the conditions or constraints from the policy information of the set of policies. With respect to the set of policies, the policy processor component 104 can determine the conditions and the constraints under which claims are to be specified or indicated as having, for example, a valid status or an invalid status.

In some embodiments, the policy processor component 104 can receive, via an interface (e.g., touchscreen, keyboard, mouse, trackpad, audio interface, . . . ), input data (e.g., from a user, such as a claim auditor or supervisor) relating to conditions and/or constraints to indicate an addition of or a maintaining (e.g., a keeping) of a condition or a constraint, a modification of a condition or a constraint, or a removal or filtering out of a condition or a constraint, with respect to the set of policies. For example, there can be instances where the policy processor component 104 can be unable to determine a particular condition or particular constraint from the analysis of the policy information of the set of policies, or where a portion of the policy information of the set of policies can be outdated and superseded by updated policy information that was not included in the set of policies. To facilitate determining at least a portion of the conditions and constraints (e.g., particular condition or particular constraint) associated with the set of policies, a user can provide, via the interface, the input data to the policy processor component 104 to facilitate adding or maintaining a condition or constraint, modifying a condition or constraint, or removing or filtering out a condition or constraint. In response to receiving (and analysis of) such input data, the policy processor component 104 can accordingly add or maintain a condition or a constraint, modify a condition or a constraint, or remove or filter out a condition or a constraint, with respect to the set of policies.

In response to determining the conditions and constraints relating to claim validity for the set of policies associated with the service entity, the policy processor component 104 can encode the conditions and the constraints relating to claim validity to generate probabilistic information. The probabilistic information can comprise, for example, probabilistic logic data, which can comprise probabilistic logic formulas, relating to (and determined based at least in part on) the conditions and the constraints. For example, a probabilistic logic formula can be determined, generated, and/or structured based at least in part on, and to correspond to, the conditions and constraints, such that factual data from a claim can be input to the probabilistic logic formula and a result, which can relate to claim validity of the claim (e.g., indicating a validity status of the claim), a probability that the validity status is accurate or correct, a reason for the validity status, and/or a probability that the reason is accurate or correct, can be produced as an output from the probabilistic logic formula. One or more probabilistic logic formulas can be utilized by the claim management component 106 to facilitate determining the validity status of the claim, the probability (e.g., probability value or percentage) that the validity status is accurate or correct, a reason (e.g., most likely reason or explanation) for the validity status, and/or a probability that the reason is accurate or correct.

The policy processor component 104 can store the probabilistic information and/or information relating to the conditions and the constraints in a knowledge database. In some embodiments, the claim processor component 102 can comprise or be associated with a knowledge database component 108 that can include the knowledge database. The policy processor component 104 can be associated with (e.g., communicatively connected to) the knowledge database component 108 and can store the probabilistic information and/or information relating to the conditions and the constraints, with respect to the set of policies, in the knowledge database of the knowledge database component 108. The claim management component 106 also can be associated with (e.g., communicatively connected to) the knowledge database component 108, and can access the knowledge database in the knowledge database component 108 to access and/or retrieve the probabilistic information from the knowledge database to facilitate determining the validity statuses of claims, as more fully described herein.

The claim management component 106 can utilize the information (e.g., probabilistic information, including probabilistic logic formulas and/or other probabilistic logic data) stored in the knowledge database to evaluate or audit claims (e.g., claims presented for payment, in connection with an insurance policy, agreement, or contract). During an audit of a claim or a set of claims, the claim management component 106 can receive the claim or set of claims. With regard to a claim, the claim management component 106 can analyze (e.g., parse) the claim to facilitate determining or identifying factual data in the claim. Based at least in part on the results of analyzing the claim, the claim management component 106 can determine or identify the factual data in the claim, and/or can extract the factual data from the claim. The claim management component 106 also can access the knowledge database of the knowledge database component 108 to retrieve probabilistic information relating to the conditions and the constraints relating to claim validity. For example, the claim management component 106 can retrieve a portion of the probabilistic information (e.g., probabilistic logic formulas and/or other probabilistic logic data) that is determined to be relevant to the factual data of the claim.

The claim management component 106 can evaluate or analyze the factual data obtained from the claim and the probabilistic information to facilitate determining the validity status of the claim, the probability that the validity status for the claim is accurate or correct, a reason (e.g., explanation) for the validity status, and/or a probability that the reason is accurate or correct. For instance, the claim management component 106 can apply the probabilistic information (e.g., probabilistic logic formulas and/or other probabilistic logic data) to the factual data to facilitate determining the validity status of the claim, the probability that the validity status for the claim is accurate or correct, the reason for the validity status, and/or the probability that the reason is accurate or correct. As an example, the claim management component 106 can use the factual data of the claim as input to one or more probabilistic logic formulas or other probabilistic logic data to produce an output (e.g., a claim validity status and/or probabilistic output) based at least in part on the factual data and the one or more probabilistic logic formulas or other probabilistic logic data.

Based at least in part on the results of evaluating the factual data relating to the claim and the probabilistic information, the claim management component 106 can determine the validity status of the claim. The validity status can be, for example, a valid status or an invalid status. The valid status can indicate the claim is determined to be valid, and the invalid status can indicate the claim is determined to be invalid.

For example, the factual data of a claim indicates that the claim does not violate a condition or constraint associated with the set of policies. Based at least in part on the results of evaluating the factual data and the probabilistic information, the claim management component 106 can determine that the claim does not violate a condition or constraint associated with the set of policies, and, accordingly, can determine that the validity status for the claim is a valid status, which can indicate that the claim has been determined to be valid.

As another example, when the factual data of a claim indicates that the claim does violate one or more conditions or constraints associated with the set of policies, the claim management component 106 can determine that the claim does violate one or more conditions or constraints associated with the set of policies, based at least in part on the results of evaluating the factual data and the probabilistic information. Accordingly, the claim management component 106 can determine that the validity status for the claim is an invalid status. The claim management component 106 can determine the particular status (e.g., invalid status) based at least in part on the type(s) of condition(s) and/or constraint(s) associated with the set of policies that was (or were) determined to be violated, in accordance with defined claim management criteria.

Also, based at least in part on the results of evaluating the factual data and the probabilistic information, the claim management component 106 can determine the probability (e.g., a probability value or percentage) that the validity status is accurate or correct. For example, in some instances, the evaluation results can indicate a relatively high probability (e.g., 95% probability) that the determined validity status for a claim is accurate or correct, and, in other instance, the evaluation results can indicate a relatively lower probability (e.g., 80% probability, 75% probability, or other level of probability) that the determined validity status for a claim is accurate or correct, depending in part on the circumstances associated with the claim (e.g., the factual data in the claim, the conditions and constraints in the set of policies, . . . ).

In some embodiments, based at least in part on the results of evaluating the factual data and the probabilistic information, the claim management component 106 can determine the reason (e.g., most likely reason) for the validity status that has the highest probability of being an accurate (e.g., correct) explanation for the validity status relative to other probabilities of other potential reasons for the validity status being the accurate reason for the validity status. In certain embodiments, based at least in part on such evaluation results, the claim management component 106 also can determine a probability (e.g., probability value or percentage) that the reason is an accurate reason for the validity status. An example of an explanation can be that a claim (which was determined to be valid) is valid because all variables are determined to be within applicable limits for the variables (e.g., a first limit applicable to a first variable, a second limit applicable to a second variable, and so on). An example explanation for an invalid claim can be that the claim is determined to be invalid because the number of units (14) for the procedure code (C977305) exceeds (or violates) the applicable limit (12) on the number of units for the procedure code. In some embodiments, the explanation can indicate the particular rule(s) that has been violated when a claim is determined (e.g., by the claim management component 106) to be invalid.

With regard to the claim that was audited, the claim management component 106 can present (e.g., display, communicate, or emit as an output), or initiate presentation of, information (e.g., claim audit information or results) relating to the validity status, the probability that the validity status is correct, the reason for the validity status, and/or the probability that the reason is an accurate explanation for the validity status. Such information can comprise visual information, audio information, and/or haptic information that can be presented via a desired interface (e.g., display screen, audio speakers or other audio interface, haptic interface, . . . ) to a user (e.g., claim auditor or other person), another entity (e.g., a business or government agency), and/or a device (e.g., communication device, such as a computer, mobile phone, electronic eyewear or bodywear having communication and/or computing functionality, electronic pad or tablet, . . . ).

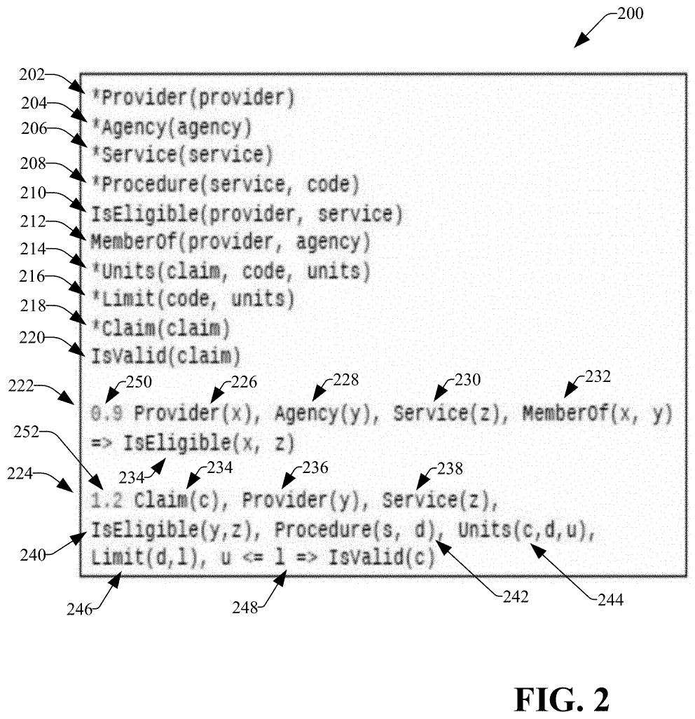

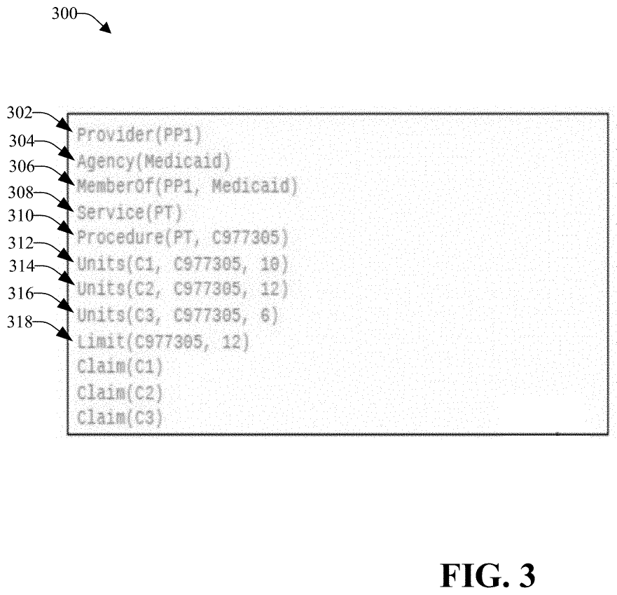

Referring to FIGS. 2 and 3 (along with FIG. 1), FIG. 2 depicts a diagram of example probabilistic logic data 200 associated with a policy document of a set of policies of a service entity, and FIG. 3 illustrates a diagram of an example auditing of claims 300, in accordance with various aspects and embodiments of the disclosed subject matter. The policy processor component 104 can determine and generate the probabilistic logic data 200 based at least in part on a result of analyzing the policy document. The policy document can comprise textual language (e.g., in natural language format), such as, for example, the following: Providers must be enrolled as a Health First Colorado (Colorado's Medicaid Program) provider in order to submit claims for payment to Health First Colorado. Members daily limit of C977305 is 12 units.

The policy processor component 104 can analyze the textual language of the policy document. In some embodiments, the textual language of the policy document can be in natural language format, and the policy processor component 104 can parse the textual language in the natural language format (e.g., using a natural language processing algorithm or techniques) to determine or identify the relevant data (e.g., terms, providers, procedure codes, conditions, constraints, . . . ; concepts, relationships between concepts, . . . ) of the policy document. Based at least in part on the analysis of the textual language of the policy document, the policy processor component 104 can identify or determine certain conditions or constraints in the policy document, such as, for example, that a provider must be enrolled as a provider with the Medicaid program in order to submit claims for payment to the Medicaid program, and the daily limit for procedure code C977305 is 12 units for members. As part of the analysis of the policy document, the policy processor component 104 can identify or determine various parameters that can relate to the probabilistic rules that can encode or include the conditions and constraints determined from the policy document. For example, the policy processor component 104 can identify or determine Provider(provider) 202, Agency(agency) 204, Service(service) 206, Procedure(service, code) 208, IsEligible(provider, service) 210, MemberOf(provider, agency) 212, Units(claim, code, units) 214, Limit(code, units) 216, Claim(claim) 218, and IsValid(claim) 220. Provider(provider) 202 can relate to the provider that is submitting the claim. Agency(agency) 204 can relate to the agency (e.g., Medicaid) that is providing the payment on the claims to the provider (e.g., an eligible provider). Service(service) 206 can relate to the particular type or area of service (e.g., physical therapy (PT), orthopedics, surgical, cardiology, . . . ) associated with the claim. Procedure(service, code) 208 can relate to a particular procedure that was performed and is associated with a claim, wherein the procedure can be related to a particular type or area of service and a particular procedure code. IsEligible(provider, service) 210 can be a parameter relating to whether a provider is eligible to be paid on a claim relating to a service and submitted for payment to the agency. MemberOf(provider, agency) 212 can relate to whether a provider is enrolled in and a member of the agency in order to be eligible to submit claims for payment by the agency. Units(claim, code, units) 214 can relate to a number of units associated with a particular claim and particular procedure code. Limit(code, units) 216 can relate to a limit on the number of units for a particular procedure code (e.g., a limit on the number of units over a defined time period). Claim(claim) 218 can relate to a claim submitted by a provider for payment. IsValid(claim) 220 can relate to a determination whether a claim is valid or not (e.g., as determined by the claim processor component 102).

The probabilistic logic data 200 can comprise rules (e.g., probabilistic rules) that can be used to process submitted claims that are under audit, wherein the rules can be based at least in part on conditions and constraints associated with the policy that were identified in or determined from the policy document by the policy processor component 104. Based at least in part on the results of the analysis of the policy document, the policy processor component 104 can determine a set of rules (e.g., probabilistic rules) that can be applied to claims under audit (e.g., by the claim management component 106) to facilitate determining the validity status of such claims. For example, with regard to the example probabilistic logic data 200, based at least in part on the results of the analysis of the policy document, the policy processor component 104 can determine and generate rule 222 and rule 224.

The rule 222 can relate to determining whether a provider is an enrolled member with an agency and is eligible to be paid on a claim relating to a service and submitted for payment to the agency (if the claim is otherwise determined to be valid based on any other applicable rule(s)). That is, the rule 222 can relate to determining whether the provider is an enrolled member with the agency with regard to the service. The rule 222 can comprise parameters associated with determining whether the provider is eligible. For instance, the rule 222 can comprise Provider(x) 226, which can relate to the provider that provided the service, Agency(y) 228, which can relate to the agency that would pay on a claim for the service, Service(z) 230, which can relate to the service performed on the patient, MemberOf(x, y)=>IsEligible(x, z) 232, which can relate to whether the provider is an enrolled member with the agency with regard to a particular service.

The rule 224 can related to determining whether a claim for a particular service is valid. The rule 224 can comprise various parameters associated with determining whether a claim is valid with regard to a particular service. For instance, the rule 224 can comprise Claim(c) 234, which can relate to the claim under audit, Provider(y) 236, which can relate to the provider that is submitting the claim for payment, Service(z) 238, which can relate to the service performed on the patient, IsEligible(y, z) 240, which can relate to whether the provider (e.g., y) is an eligible enrolled member with the agency with regard to the particular service (e.g., z) associated with the claim (e.g., c), Procedure(s, d) 242, which can relate to the procedure (e.g., service (s), and procedure code (d)) that was performed on the patient, Units(c, d, u) 244, which can relate to the number of units (e.g., u) for the procedure code (e.g., d) that was provided to the patient in connection with the claim, (e.g., c) Limit(d, l) 246, which can relate to the limit (e.g., 1) on the number of units for the procedure code (e.g., d) that can be provided to the patient (e.g., over a defined period of time), and logical equation u<=1=> IsValid(c) 248, which can indicate whether the claim (e.g., c) is valid or at least satisfies rule 224 (e.g., with regard to the number of units (e.g., u) for the procedure code that was provided to the patient in connection with the claim).

In some embodiments, the policy processor component 104 also can determine and present confidence values associated with rules, wherein a confidence value associated with a rule can indicate a confidence level that the rule accurately represents or reflects the applicable conditions or constraints of the set of policies, or portion thereof (e.g., policy document). For example, the policy processor component 104 can determine and present a confidence value of 0.9 (250) that can indicate a confidence level with regard to the rule 222 and a confidence value of 1.2 (252) that can indicate a confidence level with regard to the rule 224. Generally, the higher the confidence value, the higher the confidence level can be that the associated rule accurately represents or reflects the applicable conditions or constraints of the set of policies, or portion thereof. For instance, in the example probabilistic logic data 200, rule 224, with a confidence value of 1.2 (252), can have a higher confidence level in the accuracy of rule 224 than the confidence level in the accuracy of rule 222, which has a confidence value of 0.9 (250). In certain embodiments, the policy processor component 104 also can present other visual indicators (e.g., hues, icons, and/or markers, . . . ) to facilitate indicating a confidence level in the accuracy of a rule. For example, the policy processor component 104 can present a first hue (e.g., red) indicator (e.g., confidence value that can be red in hue, a red icon or marker, . . . ) to indicate the confidence level of the accuracy of the rule is relatively low, a second hue (e.g., yellow) indicator (e.g., confidence value that can be yellow in hue, a yellow icon or marker, . . . ) to indicate the confidence level of the accuracy of the rule is moderate, and/or a third hue (e.g., green) indicator (e.g., confidence value that can be green in hue, a green icon or marker, . . . ) to indicate the confidence level of the accuracy of the rule is relatively high.

In some embodiments, as part of the analysis of the policy document, the policy processor component 104 can determine and/or construct an ontology for the policy document (and other associated policy documents of the set of policies), and can determine and/or construct a probabilistic logic construction based at least in part on the policy document (and other associated policy documents of the set of policies) and the ontology, utilizing the algorithms (e.g., ontology construction algorithm, probabilistic logic construction algorithm) and techniques, as more fully described herein.

The claim management component 106 can utilize the set of rules to audit claims and determine whether the claims are valid. For instance, in an example scenario, the example rules 222 and 224 of the example probabilistic logic data 200 can be applied to the claims of the example auditing of claims 300 of FIG. 3, in accordance with various aspects and embodiments of the disclosed subject matter. The claims management component 106 can receive claims, including claim 1 (c1), claim 2 (c2), and claim 3 (c3). Claim 1 can include first claim data comprising the following: C1: Provider=PP1, Agency=Medicaid, Procedure=C977305, Units=10, Limit=12. Claim 2 can include second claim data comprising the following: C2: Provider=PP1, Agency=Medicaid, Procedure=C977305, Units=12, Limit=12. Claim 3 can include third claim data comprising the following: C3: Provider=PP1, Agency=Medicaid, Procedure=C977305, Units=6, Limit=12.

Using (e.g., applying) the application probabilistic rules (e.g., rule 222, rule 224), the claim management component 106 can evaluate claim 1, claim 2, and claim 3 to determine whether claim 1, claim 2, and/or claim 3 are valid or invalid. The claim management component 106 can analyze claim 1, claim 2, and claim 3 to determine or identify the factual data of the claims. In some embodiments, the claim data of the claims can be in natural language format, and the claim management component 106 can parse the language of the claims in the natural language format (e.g., using a natural language processing algorithm or techniques) to determine or identify the factual data of the claims (e.g., first claim data of claim 1, second claim data of claim 2, third claim data of claim 3, . . . ). Based at least in part on the results of analyzing claims 1, 2, and 3, the claim management component 106 can determine or identify the factual data of the claims, wherein the factual data can be or comprise the first claim data (e.g., first factual data) with respect to claim 1, the second claim data (e.g., second factual data) with respect to claim 2, and the third claim data (e.g., third factual data) with respect to claim 3.

Applying the rules (e.g., rule 222, rule 224) to the factual data of claims 1, 2, and 3, the claim management component 106 can determine that the provider is PP1, as indicated by Provider(PP1) 302; the agency is Medicaid, as indicated by Agency(Medicaid) 304; PP1 is enrolled as a member of Medicaid, as indicated by MemberOf(PP1, Medicaid) 306; the service is physical therapy, as indicated by Service(PT) 308; the procedure is physical therapy, procedure code C977305, as indicated by Procedure(PT, C977305) 310; for claim 1 (c1), the number of units for procedure code C977305 is 10, as indicated by Units(C1, C977305, 10) 312; for claim 2 (c2), the number of units for procedure code C977305 is 12, as indicated by Units(C2, C977305, 12) 314; for claim 3 (c3), the number of units for procedure code C977305 is 6, as indicated by Units(C1, C977305, 6) 316; and the limit for procedure code C977305 is 12, as indicated by Limit(C977305, 12) 318. Based at least in evaluating the factual data of claims 1, 2, and 3 using the rules (e.g., rule 222, rule 224), the claim management component 106 can determine that PP1 is an eligible enrolled member with Medicaid in connection with the physical therapy service, and can determine that claims 1, 2, and 3 are valid, in part, because the numbers of units (e.g., 10, 12, and 6) of claims 1, 2, and 3 for procedure code C977305 do not exceed the applicable limit of 12 units.

If, for example, there is a fourth claim that has the following fourth claim data: C4: Provider=PP1, Agency=Medicaid, Procedure=C977305, Units=14, Limit=12. The claim management component 106 can analyze the fourth claim to determine or identify the factual data of the fourth claim. Applying the rules (e.g., rule 222, rule 224) to the factual data of claim 4, the claim management component 106 can determine that the provider is PP1; the agency is Medicaid; PP1 is enrolled as a member of Medicaid; the service is physical therapy; the procedure is physical therapy, procedure code C977305; for claim 4 (c4), the number of units for procedure code C977305 is 14; and the limit for procedure code C977305 is 12. Based at least in evaluating the factual data of claim 4 using the rules (e.g., rule 222, rule 224), the claim management component 106 can determine that PP1 is an eligible enrolled member with Medicaid in connection with the physical therapy service, and can determine that claim 4 is invalid, in part, because the numbers of units (e.g., 14) of claim 4 for procedure code C977305 exceeds the applicable limit of 12 units. The claim management component 106 can determine the particular invalidity status based at least in part on the particular facts and circumstances surrounding that claim and/or other claims, in accordance with the defined claim management criteria.

In certain embodiments, the claim management component 106 can generate and present the claim auditing results with visual indicators (e.g., hues, icons, and/or markers, . . . ) to facilitate indicating a validity status (e.g., valid or invalid). For example, the claim management component 106 can present a first visual indicator (e.g., text that is green in hue, a green icon or marker) to indicate the validity status of a claim is valid, a second visual indicator (e.g., text that is red in hue, a red icon or marker) to indicate the validity status of a claim is invalid, and/or other visual indicators for other validity statuses.

In some embodiments, the claim management component 106 can utilize determination and/or inference algorithm, such as more fully described herein, to determine or infer claim validity statuses of claims, probabilities of the claim validity statuses being correct, explanations (e.g., reasons) for the claim validity statuses of the claims, and/or probabilities of the explanations for the claim validity statuses of the claims being correct, based at least in part on the results of analyzing the claim data of the claims (e.g., the factual data of the claims).

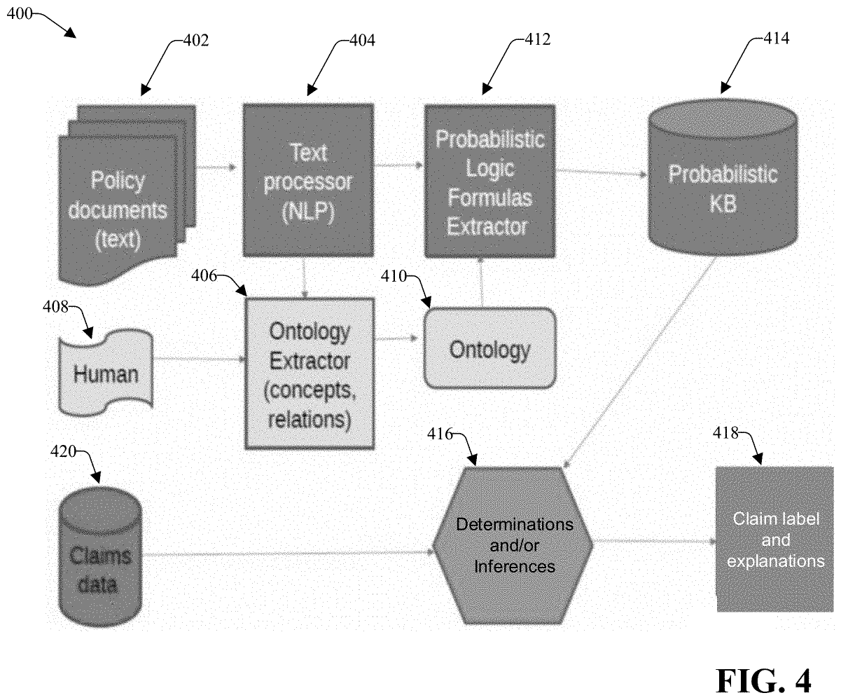

Referring to FIG. 4 (along with FIG. 1), FIG. 4 depicts a block diagram of an example flow process 400 for automated auditing of claims, in accordance with various aspects and embodiments of the disclosed subject matter. The flow process 400 can include policy documents 402 of a set of policies, which can be received by the policy processor component 104. In some embodiments, the policy documents 402 can be in a textual format, such as a natural language format. The policy processor component 104 can analyze the policy documents 402 to determine conditions and constraints relating to claims that are contained in the policy documents 402. For example, the policy processor component 104 can employ a text processor 404 to analyze the policy (e.g., perform natural language processing (NLP)) on the policy documents 402 to determine conditions and constraints relating to claims that are contained in the policy documents 402.

In some embodiments, the policy processor component 104 can analyze and process a set of policies (e.g., policy documents 402) using the following example ontology construction algorithm to facilitate an ontology construction with respect to the set of policies. For instance, the policy processor component 104 can employ an ontology extractor component 406 that can extract concepts and relations from the policy documents 402, in accordance with the example ontology construction algorithm, to facilitate the ontology construction for the set of policies, which can enable determination of conditions and constraints specified or indicated in the set of policies.

Input: A collection D of policy documents given in plain natural text

Implementation:
Let C={ } and R={ };
Loop over the policy documents (e.g., text documents) D;
   Extract concepts set C using NLP tools (e.g., standard NLP tools) for named entity extraction (e.g., using Watson natural language understanding (NLU) application programming interfaces (APIs));
   Cluster (e.g., optionally cluster) concepts into a hierarchy based, for example, on semantic similarities;
   Extract relations set R between pairs of concepts (Ci, Cj) using the NLP tools for relation extraction (e.g., using Watson NLU APIs);
   Use (e.g., optionally use) human input to filter out irrelevant relations and/or concepts; and
   Write C and R into an ontology format (e.g., standard ontology format).

As presented by the example ontology construction algorithm, the policy processor component 104 can receive, as input, a collection D of policy documents 402 that can be in plain natural text format. In implementation of the example ontology construction algorithm, the policy processor component 104 can let C={ } and R={ }, wherein C can be or represent concepts or a set of concepts, and R can be or represent relations (e.g., relations between concepts) or a set of relations, with respect to the policy information in the policy documents 402. The policy processor component 104 can loop over the policy documents 402 (e.g., policy documents D) by analyzing the policy documents 402. As part of the looping over and analyzing of the policy documents 402, the policy processor component 104 can extract concepts set C using, for example, NLP tools for named entity extraction (e.g., using Watson NLU APIs). The concepts or named entities can be or relate to, for example, providers, agencies, types of services (e.g., physical therapy), procedure codes, number of units associated with a procedure code or prescription, limits on units associated with a procedure code or prescription, types of prescriptions, etc., with regard to a set of policies (e.g., associated with health insurance). In some embodiments, the policy processor component 104 can cluster (e.g., optionally cluster) concepts (e.g., the extracted concepts) into a hierarchy based at least in part on, for example, semantic similarities that can be determined between the concepts (e.g., between pairs or groups of concepts) by the policy processor component 104.

In accordance with the example ontology construction algorithm, the policy processor component 104 also can extract relations set R between pairs of concepts (Cᵢ, C₁), for example, using the NLP tools for relation extraction (e.g., using Watson NLU APIs). For example, with regard to the example set of policies, the relations between pairs of concepts can include a relation between a procedure code and a limit on the number of units associated with the procedure code, a relation between a service (e.g., physical therapy) and a procedure code (e.g., C977305), a relation between a provider and an agency, or a relation between a provider and a service. In certain embodiments, the policy processor component 104 can utilize (e.g., optionally utilize) human input 408 to, for example, filter out irrelevant and/or otherwise undesirable relations and/or concepts from (and/or correct a relation(s) and/or concept(s) of) the relations set R and/or concepts set C. For instance, the policy processor component 104 can receive input information from a user (e.g., a claim auditor, a claim management supervisor, or other user), via an interface (e.g., touchscreen, keyboard, mouse, keypad, audio interface), that can indicate certain relations and/or concepts are irrelevant and/or undesirable. In response, the policy processor component 104 can filter out or otherwise remove, and/or modify, such certain (e.g., irrelevant and/or otherwise undesirable) relations and/or concepts.

In some embodiments, the input information can comprise supplemental policy information associated with the set of policies (e.g., but not included in the set of policies) that can be received from the user by the policy processor component 104, wherein the supplemental policy information can relate to modifications or augmentations to certain relations or concepts of the relations set R and/or concepts set C and/or additions to relations or concepts to be incorporated into the relations set R and/or concepts set C. The policy processor component 104 can analyze the supplemental policy information, and, based at least in part on the results of analyzing the supplemental policy information, can modify or augment the relations set R and/or concepts set C and/or incorporate additional relations and/or concepts into the relations set R and/or concepts set C.

In accordance with the example ontology construction algorithm, the policy processor component 104 can write C and R into a desired ontology format (e.g., a standard ontology format), based at least in part on the relations set R and/or concepts set C (e.g., as optionally filtered based at least in part on the input information received from the user), to generate an ontology 410 that can represent the policy information of the set of policies in a concept and relation (e.g., relation between concepts) form. The desired ontology format can be a web ontology language (OWL) format or other desired ontology format.

In some embodiments, the policy processor component 104 can employ a probabilistic logic formulas extractor 412 to determine, generate, and/or extract probabilistic logic formulas and/or other probabilistic logic data for the set of policies (e.g., policy documents 402) based at least in part on the results of analyzing the set of policies and the ontology 410 determined for the set of policies, for example, using the following example probabilistic logic construction algorithm.
Input: A collection D of policy documents given in plain natural text and ontology O (e.g., ontology 410)
Implementation:
   Let C={ };
   For each sentence S in document collection D,
      Extract first order logical formula C, corresponding to S, (e.g., using a long-short term memory (LSTM) sequence-to-sequence model or other desired model) to map text into an equivalent first order logic formula;
         The model can be assumed to be trained a priori;
      Align Cᵢ to ontology O using a sequence alignment algorithm (e.g., a standard sequence alignment algorithm, such as, for example, the Needleman-Wunsch algorithm);
         Discard atoms in Cᵢ that violate alignment;
         Add the aligned Cᵢ to C;

Use expectation-maximization (EM) (e.g., an EM algorithm) to learn weights for each Cᵢ to enhance or maximize the likelihood of the training data; and
Training data can comprise grounded atoms in C and/or other data extracted automatically from text and/or prepared manually.

As presented by the example probabilistic logic construction algorithm, the policy processor component 104 can receive, as input, the collection D of policy documents 402 that can be in plain natural text format and the ontology O (e.g., ontology 410). In implementation of the example probabilistic logic construction algorithm, the policy processor component 104 can let C={ }, wherein C can be or represent first order logic formulas that can be associated with (e.g., based at least in part on) the policy information in the policy documents 402. In accordance with the example probabilistic logic construction algorithm, for each sentence Sᵢ in the document collection D of the policy documents 402, the policy processor component 104 can determine or extract a first order logical formula C, that can correspond to Sᵢ (e.g., using an LSTM sequence-to-sequence model or other desired model) to map text (e.g., text of the policy documents 402) into an equivalent first order logic formula. In some embodiments, the model can be, or can be assumed to be, trained a priori (e.g., by the policy processor component 104).

In accordance with the example probabilistic logic construction algorithm, the policy processor component 104 can align the C, to the ontology O (e.g., ontology 410) using a desired sequence alignment algorithm (e.g., a standard sequence alignment algorithm, such as, for example, the Needleman-Wunsch algorithm). The policy processor component 104 can discard atoms in the Cᵢ that violate the alignment. The policy processor component 104 can add the aligned Cᵢ to C.

In some embodiments, in accordance with the example probabilistic logic construction algorithm, the policy processor component 104 can utilize the EM algorithm to determine or learn weights for each C, to enhance or maximize the likelihood of the training data. The training data can comprise grounded atoms in C and/or other data that can be extracted automatically from text and/or prepared manually (e.g., by a user). For example, with regard to Provider(x) 226 associated with rule 222 of FIG. 2, “Provider(x)” can be an atom or predicate. If the variable “x” is replaced with a provider name, such as PP1 (e.g., by the policy processor component 104), to state “Provider(PP1),” “Provider(PP1)” can be a grounded atom or grounded predicate. As another example, an atom can be “Service(z).” If the variable “z” is replaced with a name of a service, such as PT (e.g., by the policy processor component 104), to state “Service(PT),” “Service(PT)” can be a grounded atom or grounded predicate. It can be desirable to ground the atoms to that the probabilistic logic data (e.g., probabilistic logic formulas or rules) in the knowledge database (e.g., probabilistic knowledge database 414) can comprise grounded atoms (e.g., based on claim data), so that, for example, instead of a variable “x” being indicated for “Provider(x),” there can be a grounded atom, such as “Provider(PP1),” as indicated or specified by the claim (e.g., the claim record or data).

The policy processor component 104 can store probabilistic logic formulas and/or other probabilistic logic data (e.g., determined using the example probabilistic logic construction algorithm), and/or other information (e.g., information regarding conditions or constraints determined from the policy documents 402) in the knowledge database (e.g., probabilistic knowledge database 414) of the knowledge database component 108.

In certain embodiments, using the following example determination and/or inference algorithm, the claims management component 106 can determine or infer (e.g., as indicated at reference numeral 416) claim validity statuses of claims of a set (e.g., group) of claims, probabilities of the claim validity statuses being correct, explanations (e.g., reasons) for the claim validity statuses of the claims, and/or probabilities of the explanations for the claim validity statuses of the claims being correct (referred to as claim label and explanations 418), based at least in part on the results of analyzing the claim data 420 of the claims (e.g., factual data of the claims).
Input: Claims data T and the probabilistic knowledge database 414. A claim can be a record with k attributes and their corresponding values
Implementation:
   For each claim Tᵢ in T,
      Create a set of grounded atoms Gi that can correspond to claim data Ti (the attributes and the values of the attributes)
      Compute P(isValid(Gi)) using a desired probabilistic inference algorithm (e.g., a standard probabilistic inference algorithm, such as a variable elimination algorithm) over the grounded knowledge base and Gi;
      Compute a Maximum a Posteriori Probability (MAP)(isValid(Gi)) using a desired (e.g., another desired) probabilistic inference algorithm (e.g., a standard probabilistic inference algorithm, such as depth-first branch and bound search) over the grounded knowledge base and Gi;
      In both cases, isValid( ) can be a predicate associated with the validity of the claim data;
      Report P(isValid(Gi));
      Compute a MAP(isValid(Gi)), e.g., a most likely explanation of the predicate isValid(Gi);
         Given the MAP instantiation E, iteratively consider each rule Rᵢ in the knowledge database;
         If rule Rⁱ is violated by E, add Rⁱ at the collection of rules that explain the validity/invalidity (or other status) of the claim.

The claim management component 106 can receive claim data T associated with one or more claims that are being audited. A claim can be a record that can comprise k attributes and their corresponding values. The claim management component 106 also can access the knowledge database 414 (e.g., probabilistic knowledge database) to retrieve probabilistic information (e.g., probabilistic logic formulas or other probabilistic logic data) from the knowledge database 414.

For each claim Tᵢ of T, the claim management component 106 can create (e.g., generate) a set of grounded atoms Gi that can correspond to the claim data Tᵢ (e.g., the attributes (e.g., k attributes) and the values of the attributes). The claim management component 106 can determine (e.g., compute) the probability (P) that the claim is valid, for example, as P(isValid(Gi)), using a desired probabilistic inference algorithm (e.g., a standard probabilistic inference algorithm, such as a variable elimination or a sampling algorithm) over the grounded knowledge base and the set of grounded atoms Gi. The claim management component 106 can determine (e.g., compute) MAP(isValid(Gi)) using a desired (e.g., another desired and suitable) probabilistic inference algorithm (e.g., a standard probabilistic inference algorithm, such as a depth-first branch and bound search algorithm) over the grounded knowledge base and the set of grounded atoms Gi. In both cases (e.g., determining P(isValid(Gi)) and determining MAP(isValid(Gi)), isValid( ) can be a predicate associated with the validity of the claim data Tᵢ. The claim management component 106 can report the probability that the claim is valid, for example, as P(isValid(Gi)).

In some embodiments, the claim management component 106 can determine (e.g., compute) MAP(isValid(Gi)), for example, a most likely explanation of the predicate (isValid(Gi)). In certain embodiments, given the MAP instantiation E, the claim management component 106 can iteratively consider and/or evaluate each rule Ri in the knowledge database 214. If the claim management component 106 determines that a rule is violated by E, the claim management component 106 can add Ri to the collection of rules that can explain the validity or invalidity (or other type of validity status) of the claim under audit.

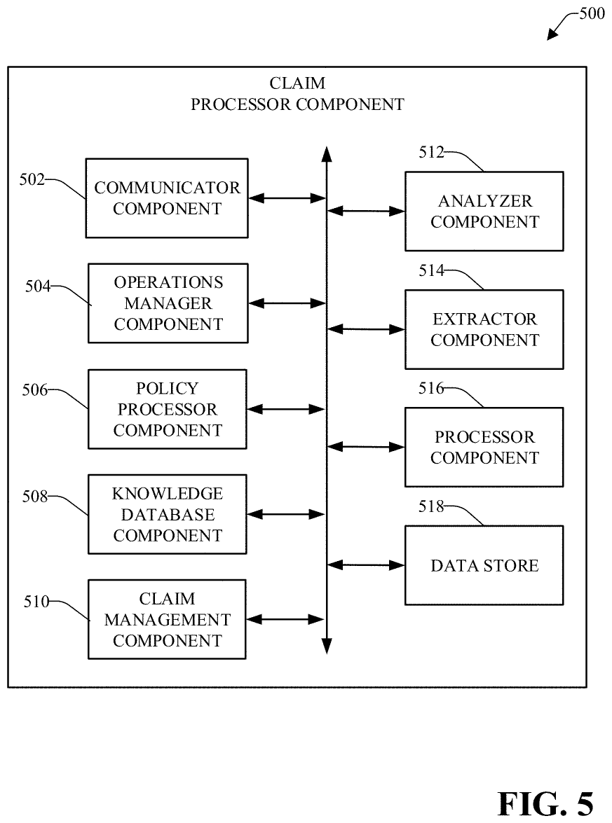

FIG. 5 presents a block diagram of an example claim processor component 500, in accordance with various aspects and embodiments of the disclosed subject matter. The claim processor component 500 can comprise a communicator component 502, an operations manager component 504, a policy processor component 506, a knowledge database component 508, a claim management component 510, an analyzer component 512, an extractor component 514, a processor component 516, and a data store 518.

The communicator component 502 can be employed to transmit information from the claim processor component 500 to another component or device (e.g., an interface or display screen, a computer, . . . ) associated with (e.g., communicatively connected to) the claim processor component 500 and/or receive information from another component or device (e.g., a touchscreen, a keyboard or keypad, a mouse, a trackpad, an audio interface, and/or another interface). For example, the communicator component 502 can communicate a validity status of a claim, a probability that the validity status is correct, an explanation (e.g., most probable explanation) for the validity status, and/or a probability that the explanation is the correct explanation to a display screen or other interface, and/or to a computer. As another example, the communicator component 502 can receive input information, via a desired interface, from a user, for instance, with regard to filtering out, removing, and/or modifying a condition, a constraint, a concept, and/or a relationship between concepts, etc., with respect to a set of policies.

The operations manager component 504 can control (e.g., manage) operations associated with the claim processor component 500. For example, the operations manager component 504 can facilitate generating instructions to have components of the claim processor component 500 perform operations, and can communicate instructions to components (e.g., communicator component 502, policy processor component 506, knowledge database component 508, claim management component 510, . . . , processor component 516, and/or data store 518, . . . ) of the claim processor component 500 to facilitate performance of operations by the components of the claim processor component 500 based at least in part on the instructions, in accordance with the defined claim management criteria and the claim management algorithm(s) (e.g., ontology construction algorithm, determination and/or inference algorithm, probabilistic inference algorithms (e.g., variable elimination, sampling algorithm, a depth-first branch and bound search algorithm)). The operations manager component 504 also can facilitate controlling data flow between the components of the claim processor component 500 and controlling data flow between the claim processor component 500 and another component(s) or device(s) (e.g., a display screen or other interface, a computer, . . . ) associated with (e.g., connected to) the claim processor component 500.

The policy processor component 506 can analyze (e.g., in conjunction with the analyzer component 512 and/or extractor component 514) a set of policies to facilitate identifying, determining, and/or extracting conditions or constraints contained in the set of policies, identifying, determining, and/or extracting concepts and relationships between concepts in the set of policies, and/or, based at least in part on the results of analyzing the set of policies, determining probabilistic logic data (e.g., probabilistic logic formulas or probabilistic rules) that can be utilized to perform automated auditing of claims, etc., as more fully described herein.

The knowledge database component 508 can comprise a knowledge database that can store the probabilistic logic data, conditions and constraints, an ontology, and/or other desired information associated with a set of policies, as more fully described herein. The knowledge database component 508 can be associated with (e.g., communicatively connected to) the policy processor component 506, claim management component 510, and other components of the claim processor component 500.

The claim management component 510 can analyze (e.g., in conjunction with the analyzer component 512 and/or extractor component 514) a claim, and identify, determine, and/or extract factual data from the claim, based at least in part on the results of the analysis of the claim, as more fully described herein. The claim management component 510 can determine the validity status of a claim, a probability that the validity status is correct, an explanation (e.g., most probable explanation) for the validity status, and/or a probability that the explanation is the correct explanation, based at least in part on the factual data of the claim and the probabilistic logic data (e.g., applying the probabilistic logic data to the factual data), as more fully described herein. The claim management component 510 can access the knowledge database and utilize the information stored therein to facilitate performing the various operations and determinations relating to validity and/or auditing of the claim.

The analyzer component 512 analyze data (e.g., policy information of a set of policies; claim data of a claim; probabilistic logic data; . . . ) to facilitate automated auditing of claims. The analyzer component 512 can operate in conjunction with the policy processor component 506 to analyze a set of policies and/or can operate in conjunction with the claim management component 510 to render or perform determinations (e.g., determine validity status and associated probability of correctness, determine explanation and associated probability that the explanation is correct) relating to validity of a claim, as more fully described herein.

The extractor component 514 can operate in conjunction with the policy processor component 506 and the claim management component 510 to facilitate performance of operations and determinations by the policy processor component 506 and the claim management component 510. The extractor component 514 can utilize NLP tools, NLU APIs, models (e.g., LSTM sequence-to-sequence model), and/or algorithms to perform the extraction of information from a set of policies or claims, as more fully described herein.

The processor component 516 can be associated with the data store 518, and the other components of the claim processor component 500. The processor component 516 can work in conjunction with the other components (e.g., communicator component 502, operations manager component 504, policy processor component 506, knowledge database component 508, claim management component 510, . . . data store 518, . . . ) to facilitate performing the various functions of the claim processor component 500. The processor component 516 can employ one or more processors, microprocessors, or controllers that can process data, such as information relating to policies, claims, probabilistic logic formulas or other probabilistic logic data, defined claim management criteria, algorithms (e.g., ontology construction algorithm, determination and/or inference algorithm, probabilistic inference algorithm, sequence alignment algorithm, . . . ), data traffic flows (e.g., between components or devices, and/or across a network(s)), protocols, policies, interfaces, tools, and/or other information, to facilitate operation of the claim processor component 500, as more fully disclosed herein, and control data flow between components of the claim processor component 500, control data flow between the claim processor component 500 and other components or devices (e.g., interfaces, applications, computers, . . . ) associated with the claim processor component 500. In accordance with various embodiments, the processor component 516 can comprise one or more processor components, floating-point units (FPUs)), graphics processing units (GPUs), accelerators, field-programmable gate arrays (FPGAs), and/or other processing units to perform or facilitate performing operations on data, including performing calculations on data.

The data store 518 can store data structures (e.g., user data, metadata), code structure(s) (e.g., modules, objects, hashes, classes, procedures) or instructions, information relating to policies, claims, probabilistic logic formulas or other probabilistic logic data, defined claim management criteria, algorithms (e.g., ontology construction algorithm, determination and/or inference algorithm, probabilistic inference algorithm, sequence alignment algorithm, . . . ), data traffic flows (e.g., between components or devices, and/or across a network(s)), protocols, policies, interfaces, tools, and/or other information, to facilitate controlling operations associated with the claim processor component 500. In an aspect, the processor component 516 can be functionally coupled (e.g., through a memory bus or other bus) to the data store 518 in order to store and retrieve information desired to operate and/or confer functionality, at least in part, to the communicator component 502, operations manager component 504, policy processor component 506, knowledge database component 508, claim management component 510, analyzer component 512, extractor component 514, processor component 516, and data store 518, and/or other components of the claim processor component 500, and/or substantially any other operational aspects of the claim processor component 500.

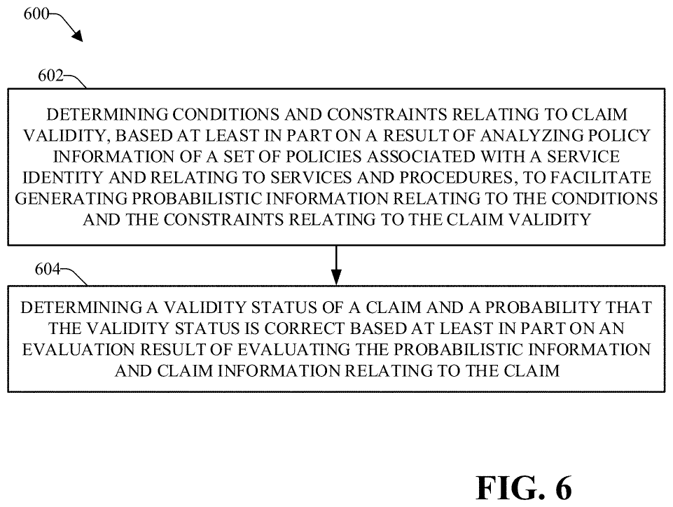

FIG. 6 illustrates a flow diagram of an example, non-limiting method 600 for automated auditing of claims, in accordance with various aspects and embodiments of the disclosed subject matter. The method 600 can be performed by, for example, the processor component and/or the claim processor component, which can comprise the policy processor component and the claim management component. Repetitive description of like elements employed in other embodiments described herein is or may be omitted for sake of brevity.

At 602, conditions and constraints relating to claim validity can be determined, based at least in part on a result of analyzing policy information of a set of policies associated with a service identity and relating to services and procedures, to facilitate generating probabilistic information relating to the conditions and the constraints relating to the claim validity. A service entity (e.g., insurance company or other type of company, person, or other entity that can desire claims to be audited), having a service identity, can have or be associated with the set of policies (e.g., one or more policies) that can comprise the policy information relating services (e.g., medical services, automobile repair or replacement services, home repair or replacement services, life insurance-related services, mortgage insurance-related services, . . . ) and procedures (e.g., procedure codes). The policy information of the set of policies can comprise, for example, rules associated with the services and rules associated with procedure codes relating to the procedures or services. The policy processor component can determine the conditions and the constraints relating to claim validity, based at least in part on a result of analyzing the policy information of the set of policies associated with the service identity, to facilitate generating probabilistic information relating to the conditions and the constraints relating to the claim validity.

At 604, a validity status of a claim and a probability that the validity status is correct can be determined based at least in part on an evaluation result of evaluating the probabilistic information and claim information relating to the claim. The claim management component can evaluate the probabilistic information and the claim information relating to the claim. Based at least in part on the evaluation result of evaluating the probabilistic information and the claim information, the claim management component can determine the validity status of the claim and the probability (e.g., a probability value or percentage) that the validity status is correct. The validity status can be, for example, a valid status that can indicate that the claim is determined to be valid or an invalid status that can indicate the claim is determined to be invalid. In some embodiments, the claim management component can determine an explanation (e.g., reason) for the validity status that has the highest probability of being an accurate explanation for the validity status relative to other probabilities of other explanations for the validity status being the accurate explanation for the validity status, and can provide (e.g., present, display, or communicate), via an interface, such explanation with the validity status and the probability, for example, to a user (e.g., a claim auditor).

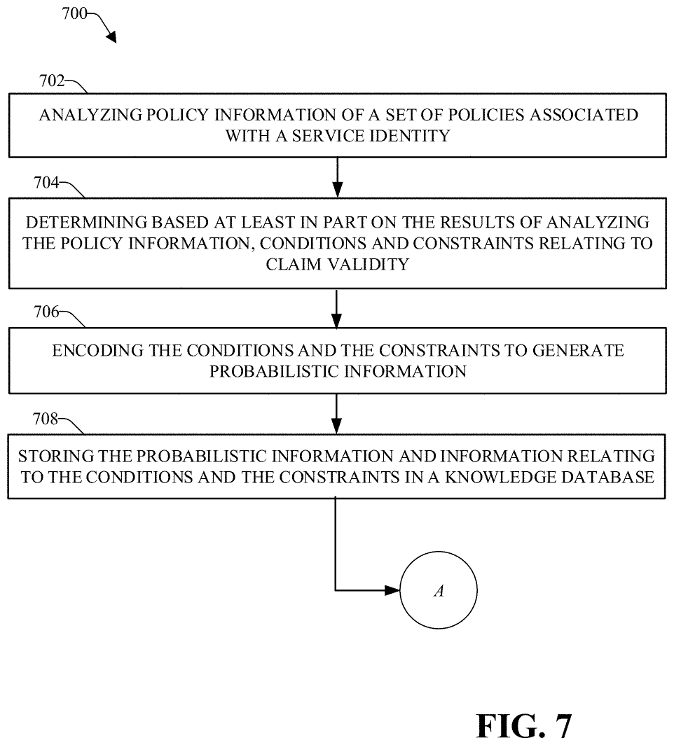

FIG. 7 depicts a flow diagram of an example, non-limiting method 700 for generating probabilistic information relating to conditions and constraints relating to claim validity from a set of policies associated with a service identity, and storing the probabilistic information in a knowledge database, to facilitate automated auditing of claims, in accordance with various aspects and embodiments of the disclosed subject matter. The method 700 can be performed by, for example, the processor component and/or the claim processor component, which can comprise the policy processor component and the claim management component. Repetitive description of like elements employed in other embodiments described herein is or may be omitted for sake of brevity.

At 702, policy information of a set of policies associated with a service identity can be analyzed. A service entity (e.g., insurance company or other type of company, person, or other entity that can desire claims to be audited), having a service identity, can have or be associated with the set of policies (e.g., one or more policies) that can comprise the policy information relating services (e.g., medical services, automobile repair or replacement services, home repair or replacement services, life insurance-related services, mortgage insurance-related services, . . . ) and procedures (e.g., procedure codes). The policy information of the set of policies can comprise, for example, rules associated with the services and rules associated with procedure codes relating to the procedures or services. The policy processor component can receive the set of policies and analyze the policy information of the set of policies associated with the service identity.

In some embodiments, all or a portion of the policy information of the set of policies can be in natural language format. As part of the analyzing of the policy information, the policy processor component can employ natural language format analysis, wherein the policy processor component can parse the policy information in the natural language format to facilitate determining the conditions and the constraints relating to the claim validity that are associated with the set of policies.

At 704, based at least in part on the results of analyzing the policy information, conditions and constraints relating to claim validity can be determined. The policy processor component can determine the conditions and the constraints relating to claim validity, based at least in part on the results of analyzing the policy information of the set of policies, to facilitate generating probabilistic information relating to the conditions and the constraints relating to claim validity. For instance, the policy processor component can determine the conditions and the constraints under which claims are to be indicated as having, for example, a valid status or an invalid status.

In some embodiments, the policy processor component can receive, via an interface (e.g., touchscreen, keyboard, mouse, trackpad, audio interface, . . . ), input data (e.g., from a user) relating to conditions and/or constraints to indicate an addition of or a maintaining (e.g., a keeping) of a condition or a constraint, a modification of a condition or a constraint, or a removal or filtering out of a condition or a constraint, with respect to the set of policies, as more fully described herein. In response to receiving and analyzing such input data, the policy processor component can accordingly add or maintain a condition or a constraint, modify a condition or a constraint, or remove or filter out a condition or a constraint, with respect to the set of policies.

At 706, the conditions and the constraints can be encoded to generate probabilistic information. The policy processor component can encode the conditions and the constraints relating to claim validity, as such conditions and constraints were determined from the policy information, to generate the probabilistic information. The probabilistic information can comprise, for example, probabilistic logic data, which can comprise probabilistic logic formulas, relating to (and determined based at least in part on) the conditions and the constraints.

At 708, the probabilistic information and information relating to the conditions and the constraints can be stored in a knowledge database. The policy processor component can store the probabilistic information and information relating to the conditions and the constraints in the knowledge database (e.g., in the knowledge database of the knowledge database component).

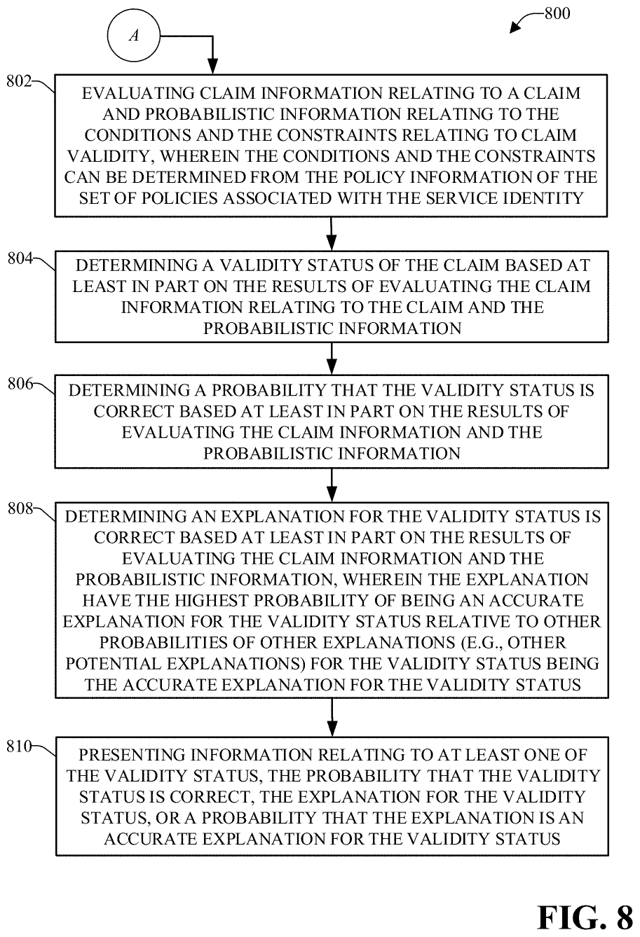

In certain embodiments, the method 700 can proceed to reference point A, wherein the method 800 of FIG. 8 can proceed from reference point A to facilitate determining a validity status of a claim, a probability that the claim status for the claim is correct, and/or an explanation (e.g., most likely explanation or reason) for the validity status.

FIG. 8 illustrates a flow diagram of an example, non-limiting method 800 for determining the validity status of a claim to facilitate automated auditing of claims, in accordance with various aspects and embodiments of the disclosed subject matter. The method 800 can be performed by, for example, the processor component and/or the claim processor component, which can comprise the policy processor component and the claim management component. Repetitive description of like elements employed in other embodiments described herein is or may be omitted for sake of brevity. In some embodiments, the method 800 can proceed from reference point A (e.g., where the method 700 of FIG. 7 ended) to facilitate determining a validity status of a claim, a probability that the claim status for the claim is correct, and/or an explanation (e.g., most likely explanation or reason) for the validity status.

At 802, claim information relating to a claim and probabilistic information relating to the conditions and the constraints relating to claim validity can be evaluated, wherein the conditions and the constraints can be determined from the policy information of the set of policies associated with the service identity. The claim management component can receive the claim, including the claim information, for auditing (e.g., automated claim auditing) by the claim management component. The claim management component can access the knowledge database (e.g., knowledge database of the knowledge database component) to retrieve the probabilistic information relating to the conditions and the constraints relating to claim validity from the knowledge database.

The claim management component can evaluate or analyze the claim information and the probabilistic information to facilitate determining the validity status of the claim, the probability that the claim status for the claim is correct, and/or an explanation (e.g., most likely explanation or reason) for the validity status. As part of the evaluation or analysis of the claim information, the claim management component can parse the claim information, and based at least in part on the results of the parsing, can extract factual information that is determined to relate to one or more facts associated with an event, a physical condition associated with a user identity (e.g., patient), a structure (e.g., a house or building), and/or a vehicle (e.g., automobile, truck, or motorcycle), etc., in connection with the claim.

The claim management component can evaluate or analyze the factual information obtained from the claim and the probabilistic information to facilitate determining the validity status of the claim, the probability that the claim status for the claim is correct, and/or the explanation for the validity status. For instance, the claim management component can apply the probabilistic information (e.g., probabilistic logic data, which can comprise probabilistic logic formulas) to the factual information to facilitate determining the validity status of the claim, the probability that the claim status for the claim is correct, and/or the explanation for the validity status.

At 804, a validity status of the claim can be determined based at least in part on the results of evaluating the claim information relating to the claim and the probabilistic information. The claim management component can determine the validity status of the claim based at least in part on the results of evaluating the claim information relating to the claim and the probabilistic information. The validity status can be, for example, a valid status or an invalid status, as more fully described herein.

For example, when a claim does not violate a condition or constraint associated with the set of policies, the claim management component can determine that the claim does not violate a condition or constraint associated with the set of policies, based at least in part on the results of evaluating the claim information and the probabilistic information. Accordingly, the claim management component can determine that the validity status for the claim is a valid status, which can indicate that the claim has been determined to be valid.

As another example, when a claim does violate a condition(s) or constraint(s) associated with the set of policies, based at least in part on the results of evaluating the claim information and the probabilistic information, the claim management component can determine that the claim does violate at least one condition or constraint associated with the set of policies, and, accordingly, can determine that the validity status for the claim is an invalid status. The claim management component can determine the particular status (e.g., invalid status) based at least in part on the type(s) of condition(s) and/or constraint(s) associated with the set of policies that was (or were) determined to be violated.

At 806, a probability that the validity status is correct can be determined based at least in part on the results of evaluating the claim information and the probabilistic information. The claim management component can determine the probability (e.g., a probability value or percentage) that the validity status is correct based at least in part on the results of evaluating the claim information relating to the claim and the probabilistic information (e.g., probabilistic logic data, which can comprise probabilistic logic formulas), as more fully described herein.

At 808, an explanation for the validity status is correct can be determined based at least in part on the results of evaluating the claim information and the probabilistic information, wherein the explanation have the highest probability of being an accurate explanation for the validity status relative to other probabilities of other explanations (e.g., other potential explanations) for the validity status being the accurate explanation for the validity status. Based at least in part on the results of evaluating the claim information relating to the claim and the probabilistic information, the claim management component can determine the explanation for the validity status that has the highest probability of being an accurate (e.g., correct) explanation for the validity status relative to other probabilities of other explanations for the validity status being the accurate explanation for the validity status, as more fully described herein. In some embodiments, based at least in part on such evaluation results, the claim management component can determine a probability (e.g., probability value or percentage) that the explanation is an accurate explanation for the validity status.

At 810, information relating to at least one of the validity status, the probability that the validity status is correct, the explanation (e.g., most likely explanation) for the validity status, or a probability that the explanation is an accurate explanation for the validity status can be presented. The claim management component can present (e.g., display, communicate, or emit as an output), or initiate presentation of, the information relating to the validity status, the probability that the validity status is correct, the explanation for the validity status, and/or the probability that the explanation is an accurate explanation for the validity status. Such information can comprise visual information, audio information, and/or haptic information, and such information can be presented via a desired interface (e.g., display screen, audio speakers or other audio interface, haptic interface, . . . ).

For simplicity of explanation, the methods and/or computer-implemented methods are depicted and described as a series of acts. It is to be understood and appreciated that the disclosed subject matter is not limited by the acts illustrated and/or by the order of acts, for example acts can occur in various orders and/or concurrently, and with other acts not presented and described herein. Furthermore, not all illustrated acts can be required to implement the computer-implemented methods in accordance with the disclosed subject matter. In addition, those skilled in the art will understand and appreciate that the computer-implemented methods could alternatively be represented as a series of interrelated states via a state diagram or events. Additionally, it should be further appreciated that the computer-implemented methods disclosed hereinafter and throughout this specification are capable of being stored on an article of manufacture to facilitate transporting and transferring such computer-implemented methods to computers. The term article of manufacture, as used herein, is intended to encompass a computer program accessible from any computer-readable device or storage media.

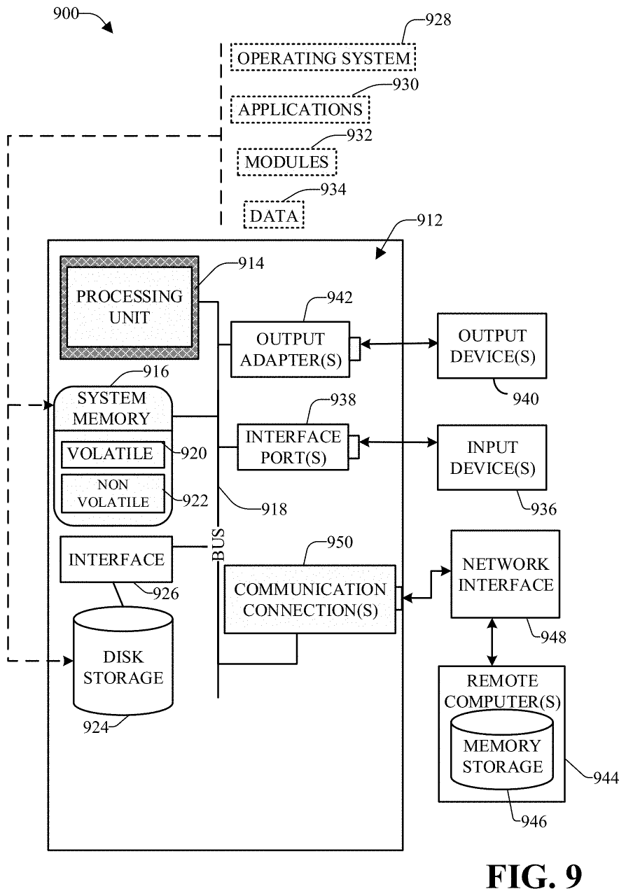

In order to provide a context for the various aspects of the disclosed subject matter, FIG. 9 as well as the following discussion are intended to provide a general description of a suitable environment in which the various aspects of the disclosed subject matter can be implemented. FIG. 9 illustrates a block diagram of an example, non-limiting operating environment in which one or more embodiments described herein can be facilitated. Repetitive description of like elements employed in other embodiments described herein is or may be omitted for sake of brevity. With reference to FIG. 9, a suitable operating environment 900 for implementing various aspects of this disclosure can also include a computer 912. The computer 912 can also include a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914. The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 916 can also include volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM)). Volatile memory 920 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 can also include removable/non-removable, volatile/nonvolatile computer storage media. FIG. 9 illustrates, for example, a disk storage 924. Disk storage 924 can also include, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used, such as interface 926. FIG. 9 also depicts software that acts as an intermediary between users and the basic computer resources described in the suitable operating environment 900. Such software can also include, for example, an operating system 928. Operating system 928, which can be stored on disk storage 924, acts to control and allocate resources of the computer 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems. A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a method of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a computer, a server, a router, a network PC, a workstation, a microprocessor based appliance, a peer device or other common network node and the like, and typically can also include many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 950 refers to the hardware/software employed to connect the network interface 948 to the system bus 918. While communication connection 950 is shown for illustrative clarity inside computer 912, it can also be external to computer 912. The hardware/software for connection to the network interface 948 can also include, for exemplary purposes only, internal and external technologies such as, modems including regular telephone grade modems, cable modems and DSL modems, ISDN adapters, and Ethernet cards.

One or more embodiments may be a system, a method, an apparatus and/or a computer program product at any possible technical detail level of integration. The computer program product can include a computer readable storage medium (or media) having computer readable program instructions thereon for causing a processor to carry out aspects of the one or more embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the disclosed subject matter can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the disclosed subject matter.

Aspects of disclosed subject matter are described herein with reference to flowchart illustrations and/or block diagrams of methods, apparatus (systems), and computer program products according to embodiments of the subject disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can be implemented in combination with other program modules. Generally, program modules include routines, programs, components, data structures, etc. that perform particular tasks and/or implement particular abstract data types. Moreover, those skilled in the art will appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other method to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM)). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor, operatively coupled to the memory, that executes computer-executable components, the computer-executable components comprising:
a policy processor component that determines conditions and constraints relating to claim validity, based on a result of an analysis of policy data of a set of policies associated with a service identity and relating to services and procedures, to facilitate generation of probabilistic logic data relating to the conditions and the constraints relating to the claim validity; and
a claim management component that determines a validity status of a claim and a probability that the validity status is correct based on an evaluation of the probabilistic logic data and claim data relating to the claim.

2. The system of claim 1, wherein the validity status is selected from a group of validity statuses consisting of a valid status that indicates the claim is determined to be valid and an invalid status that indicates the claim is determined to be invalid.

3. The system of claim 1, wherein the policy processor component analyzes the policy data to generate results, comprising the result, of the analysis, and, based on the result, determines the conditions and the constraints under which claims are to be indicated as a valid status or an invalid status.

4. The system of claim 1, wherein the claim management component determines a reason for the validity status, and wherein the claim management component determines that the reason has a highest probability of being a correct reason for the validity status as compared to other reasons for the validity status that are potentially the correct reason.

5. The system of claim 1, wherein the claim management component facilitates, via an interface component, presentation of information relating to at least one of the validity status, the probability that the validity status is correct, a reason for the validity status, or a probability that the reason is a correct reason for the validity status.

6. The system of claim 1, wherein the policy data is in a natural language format, and wherein the policy processor component analyzes the policy data in the natural language format to determine the conditions and the constraints relating to the claim validity that are associated with the set of policies.

7. The system of claim 1, wherein the policy processor component encodes the conditions and the constraints to generate the probabilistic logic data, and stores the probabilistic logic data and information relating to the conditions and the constraints in a knowledge database component, and wherein the probabilistic logic data comprises probabilistic logic formulas relating to the conditions and the constraints.

8. The system of claim 1, wherein the claim management component evaluates the probabilistic logic data and the claim data relating to the claim, and determines the validity status of the claim and the probability that the validity status is correct based on evaluation results of the evaluation.

9. The system of claim 1, wherein the policy processor component receives, via an interface component, input data that indicates a first condition of the conditions, indicates a first constraint of the constraints, filters out a second condition, or filters out a second constraint.

10. A computer-implemented method, comprising:
determining, by a system operatively coupled to a processor, conditions and constraints relating to claim validity, based on a result of analyzing policy information of a set of policies associated with a service identity and relating to services and procedures, to facilitate generating probabilistic information relating to the conditions and the constraints relating to the claim validity; and
determining, by the system, a validity status of a claim and a probability that the validity status is correct based on an evaluation result of evaluating the probabilistic information and claim information relating to the claim.

11. The computer-implemented method of claim 10, wherein the validity status is selected from a group of validity statuses consisting of a valid status that indicates the claim is determined to be valid and an invalid status that indicates the claim is determined to be invalid.

12. The computer-implemented method of claim 10, further comprising:
analyzing, by the system, the policy information to generate results, comprising the result; and
based on the result, determining, by the system, the conditions and the constraints under which claims are to be indicated as a valid status or an invalid status.

13. The computer-implemented method of claim 10, further comprising:
determining, by the system, an explanation for the validity status that has a highest probability of being an accurate explanation for the validity status relative to other probabilities of other explanations for the validity status being the accurate explanation for the validity status.

14. The computer-implemented method of claim 10, further comprising:
initiating, by the system, a display of information relating to at least one of the validity status, the probability that the validity status is correct, an explanation for the validity status, or a probability that the explanation is an accurate explanation for the validity status.

15. The computer-implemented method of claim 10, wherein the policy information is in a natural language format, wherein the policy information comprises rules associated with the services and rules associated with procedure codes relating to the procedures, and wherein the analyzing comprises parsing the policy information in the natural language format to determine the conditions and the constraints relating to the claim validity that are associated with the set of policies.

16. The computer-implemented method of claim 10, further comprising:
encoding, by the system, the conditions and the constraints to generate the probabilistic information; and
storing the probabilistic information and information relating to the conditions and the constraints in a knowledge database, and wherein the probabilistic information comprises probabilistic logic formulas relating to the conditions and the constraints.

17. The computer-implemented method of claim 10, further comprising:
evaluating, by the system, the probabilistic information and the claim information relating to the claim to generate evaluation results, comprising the evaluation result, wherein the evaluating comprises extracting factual information from the claim, wherein the claim information comprises the factual information that is determined to relate to one or more facts associated with an event or a physical condition associated with a user identity.

18. The computer-implemented method of claim 10, further comprising:
determining, by the system, that the claim violates a condition or a constraint that indicates the claim is invalid, based on the evaluation result of the evaluating of the probabilistic information and the claim information, wherein the conditions comprise the condition, and wherein the constraints comprise the constraint; and
determining, by the system, that the validity status of the claim is an invalid status based on the determining that the claim violates the condition or the constraint that indicates the claim is invalid.

19. A computer program product that facilitates evaluating a validity of a claim, the computer program product comprising a computer readable storage medium having program instructions embodied therewith, the program instructions are executable by a processor to cause the processor to:
determine conditions and constraints relating to claim validity, based on a result of an analysis of policy data of a set of policies associated with a service identity and relating to services and procedures, to facilitate generation of probabilistic logic data relating to the conditions and the constraints relating to the claim validity; and
determine a validity status of a claim and a probability that the validity status is correct based on an evaluation of the probabilistic logic data and claim data relating to the claim.

20. The computer program product of claim 19, wherein the program instructions are executable by the processor to cause the processor to:
determine an explanation for the validity status that has a highest probability of being a correct explanation for the validity status as compared to other explanations for the validity status that are potentially the correct explanation, and wherein the validity status is selected from a group of validity statuses consisting of a valid status that indicates the claim is determined to be valid and an invalid status that indicates the claim is determined to be invalid.
